(19) United States
(12) Patent Application Publication
(10) Pub. No.: US 2006/0009368 A1
(43) Pub. Date: Jan. 12, 2006

(54) Alkylglycidol carbonates as cosurfactants

(76) Inventors: Ralf Noerenberg, Ingelheim (DE); Michael Kluge, Ludwigshafen (DE); Christian Wulff, Mannheim (DE); Jurgen Tropsch, Romerberg (DE); Martin Scholtissek, Wachenheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/528,700

(22) PCT Filed: Sep. 30, 2003
(86) PCT No.: PCT/EP03/10841

§ 371 Date: Mar. 22, 2005

(30) Foreign Application Priority Data
Oct. 1, 2002 (DE) 102-46-139.2

(51) Int. Cl. C11D 17/00

(52) U.S. Cl. 510/421

(57) ABSTRACT

The present invention relates to novel alkylglycidol carbonates and to their use as cosurfactants. The cosurfactants are suitable for use in household detergents, household cleaners, body-cleansing compositions and body care compositions.

The present invention relates to alkylglycidol carbonates and to their use as cosurfactants.

Surfactants are so-called amphiphilic molecules which have a hydrophobic moiety and a hydrophilic moiety in their molecular structure. As a result of this property, surfactants are able to form interfacial films and so-called micelles. These are aggregates of surfactants which form in aqueous solutions and can assume various forms (spheres, rods, disks). Micelles form above a certain concentration, the so-called critical micelle formation concentration (CMC). In addition, amphiphilic molecules have the property of forming interfacial films between hydrophobic and hydrophilic phases and thus, for example, having an emulsifying or foaming action.

Cosurfactants likewise have amphiphilic properties, although these are insufficient for being able to form micelles and interfacial films on their own. However, they are intercalated between the surfactants and bring about an increase in the packing density of the amphiphiles (surfactants and cosurfactants) in the structures formed thereby, such as micelles or interfaces. As a result, not only are the critical micelle formation concentration and the surface tension reduced, but also the interfacial tension between the aqueous surfactant solution and nonpolar substances such as, for example, oils, meaning that the absorption capacity of the surfactant system for these substances increases to the point of the formation of microemulsions. This results in a high solubilizing and emulsifying power, a higher cleaning capacity, and an increased stability of the emulsions and foams. If cosurfactants are used, micelles can be formed at a significantly lower surfactant concentration.

Further effects which are brought about as a result of the use of the cosurfactants and the resulting enhanced aggregation tendency of the amphiphiles are known. This is, firstly, the aggregation transformation of spherical to anisometric micellar associates. This structural change in the micelles has effects on the rheology of the solutions containing the micelles, in particular in dilute solutions. At the same time, in the phase diagram, there is a shift of liquid crystalline structures present to lower concentrations, as a result of which a preferred formation of gel phases with higher packing density is observed. Consequently, even at concentrations of significantly <10% by weight, lamellar micelle structures arise which are otherwise observed only at significantly higher concentrations. A further interesting phenomenon is the formation, in addition to the known liquid crystalline gel phases, of novel superstructures which have interesting application properties. Of particular interest here are vesicular phases and also so-called L₃ phases which have a sponge-like construction and have microemulsion-like properties. They can be used in dilute concentration ranges to adjust the viscosity.

The prior art describes a number of compounds or classes of compounds which are suitable as cosurfactants.

C₅-C₁₀-alcohols exhibit advantageous properties, but are often not used due to their characteristic odor.

Alcohols with low degrees of ethoxylation, such as, for example, lauryl alcohol ethoxylates with low degrees of ethoxylation, diethylene glycol monohexyl ether or propylene glycol butyl ether, can lead to improved emulsifying power or foam stability in some surfactant systems, but have too low a polarity of the head group for surfactant formulations with a high anionic surfactant content.

Fatty acid ethanolamines are used, for example, for adjusting the viscosity in shampoos. However, they are suspected of forming nitrosamines.

G. J. Smith describes in Seifen, Ölen, Fette, Wachse, 105 (1979, pages 319 ff and 345 ff) the use of alkylamine oxides as cosurfactant in various application. These too are suspected of containing nitrosamines. Through a lengthy, complex production technology, that can be largely avoided.

Analogously to the amine oxides, other zwitterionic surfactants, such as, for example, sulfobetaines or carboxylammoniobetaines, can also be used as cosurfactant. With these products, the formation of gel phases has proven to be very poor. Instead, however, they have the application advantage that the skin irritancy of corresponding surfactant mixtures is reduced.

WO 98/00418 discloses alkylene carbonates which are substituted by alkyl groups and their use as cosurfactants.

WO 97/04059 relates to cleaning compositions which comprise an analephotropic negatively charged complex which is constructed from at least one anionic surfactant and an alkylene carbonate complexed therewith. In addition, the cleaning compositions can optionally comprise a cosurfactant, a water-insoluble hydrocarbon, a perfume, a Lewis base or a neutral polymer. The alkylene carbonate has a C₄-C₁₄-alkyl radical.

For the applications known to date, the ratio of cosurfactants to surfactants used varies from about 1:20 to 1:2, depending on the application. In some cases, such as, for example, alkylamine oxides, the cosurfactant can also be more highly concentrated.

It is an object of the present invention to provide compounds which are suitable as cosurfactants which do not have said disadvantages, in particular demonstrate very good cost efficiency and effectiveness, and are environmentally compatible and free from risks for humans.

We have found that this object is achieved by alkylglycidol carbonates of the formula I 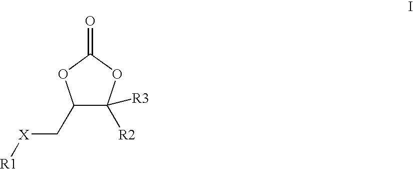
in which the symbols X, R¹, R² and R³ have the following meanings:

R¹ is a linear or branched, substituted or unsubstituted C₃-C₂₉-alkyl group or a linear or branched, substituted or unsubstituted C₃-C₂₉-alkenyl group,

R¹ is preferably a linear or branched C₃-C₂₁-alkyl group or a linear or branched C₃-C₂₁-alkenyl group, particularly preferably a linear or branched C₅-C₁₈-alkyl group or a linear or branched C₃-C₁₈-alkenyl group, very particularly preferably a linear or branched C₅-C₁₅-alkyl group or a linear or branched C₅-C₁₅-alkenyl group;

R² and R³, independently of one another, are hydrogen or a linear or branched alkyl group, preferably hydrogen or a linear or branched alkyl group having 1 to 5 carbon atoms, particularly preferably, at least one of the radicals R² or R³ is hydrogen, and very particular preference is given to compounds of the formula I in which R² and R³ are hydrogen;

X is chosen from the group consisting of O, O(CH₂CHR⁴O)ₙ, S, NR⁵, COO and CONH, in which R⁴ and R⁵ are hydrogen, methyl, ethyl or propyl, and n is a number from 1 to 5, where mixtures of compounds with groups X of the formula O(CH₂CHR⁴O)ₙ are also included by the formula I, in which n has various numerical values; preferably, X is O, O(CH₂CHR⁴O)ₙ or NR⁵, where the meanings for R⁴, R⁵ and n correspond to the meanings given above; particularly preferably, X is O.

The compounds of the formula I are highly suitable for use as cosurfactants in customary detergent and cleaning formulations known to the person skilled in the art.

The compounds of the formula I can be produced in various ways, e.g. methods a) and b) described in more detail below, corresponding to the production of alkylene carbonates disclosed in WO 98/00418.

a) Phosgene Method

Firstly, a reaction of 1,2-diols of the formula II functionalized with an R¹—X—CH₂ group with phosgene is possible in accordance with the following reaction scheme.

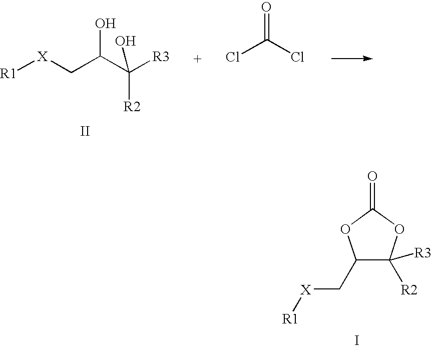

The meanings of the symbols X, R¹, R² and R³ correspond to the meanings given above.

In a preferred embodiment, the reaction is carried out by adding a chilled solution of phosgene in an aromatic solvent, preferably toluene, to give a chilled solution of the 1,2-diol of the formula II functionalized with an R¹—X—CH₂ group in an aromatic solvent, likewise preferably toluene, in the presence of a base, preferably an amine, particularly preferably triethylamine or dimethylcyclohexylamine, for the neutralization of HCl formed during the reaction. The temperature during the addition should not exceed 0° C. It is preferably −5° C. to 0° C. After heating the reaction mixture to room temperature, the reaction is continued for, in general, 1 to 20 hours, preferably 12 to 16 hours, at room temperature. When the reaction is complete, work-up and subsequent purification of the desired alkylglycidol carbonate take place in accordance with methods known to the person skilled in the art. The amine base preferably used can, if desired, be isolated as the hydrochloride and, after freeing the amine and optionally separating off water, be returned to the process.

Phosgene is generally used in 0-50% strength molar excess, preferably in 0-20% strength molar excess, relative to the diol of the formula II. In this connection, a 0% excess means that phosgene and the diol are used in equimolar amounts. The base used is generally used in a molar ratio to phosgene of, in general, 2:1 to 4:1, preferably 2:1 to 2.25:1.

The 1,2-diols of the formula II are obtainable, for example, by epoxidation of a suitable internal or α-olefin, giving an epoxide of the formula III:

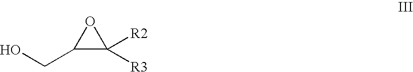

Some of the epoxides of the formula III can also be obtained commercially, e.g. glycidol itself.

The epoxide of the formula III is then reacted to give a functionalized diol of the formula II:

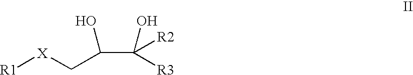

The meanings of the symbols X, R¹, R² and R³ correspond to the meanings given above.

The functionalization takes place, for example, by reacting the epoxide III with suitable alcohols, thiols, alcohols reacted with alkylene oxides, amines, carboxylic acids or their carboxamides. Suitable compounds of this group are given below.

In principle, diols of the formula II are also obtainable by hydrolysis of epoxides of the formula IV.

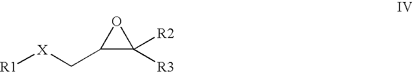

The hydrolysis of the epoxide of the formula IV leads to the desired diols of the formula II. Suitable hydrolysis conditions are known to the person skilled in the art. Some of the suitable diols can be obtained commercially.

The production of the epoxides IV can be carried out, for example, by reacting a nucleophile R1-XH with epichlorohydrin and subsequent HCl elimination. For the reaction with epichlorohydrin, an acidic catalyst may be added. HCl can be eliminated, for example, by mixing the reaction product of epichlorohydrin and nucleophile with aqueous sodium hydroxide solution and optional warming. Such reactions are known to the person skilled in the art and are described in detail in the application, filed at the same time, with the title “Reaction products of 2-propylheptanol” (DE-A 102 46 140) using the example of 2-propylheptanol as nucleophile.

b) CO₂ Insertion

In accordance with this reaction, the functionalized epoxides of the formula IV are reacted with CO₂ using a catalyst according to the following reaction scheme (Paddock, Nguyen, J. Am. Chem. Soc. 2001, 123, 11498; Kisch, Millini, Wang, Chem. Ber. 1986, 119 (3), 1090; Baba, Nozaki, Matsuda, Bull. Chem. Soc. Jpn. 1987, 60 (4), 1552; Lermontov, Velikokhat'ko, Zavorin, Russ. Chem. Bull. 1998, 47 (7), 1405; Rokicki, Kuran, Pogorzelska-Marciniak, Monatshefte für Chemie 1984, 115, 205):

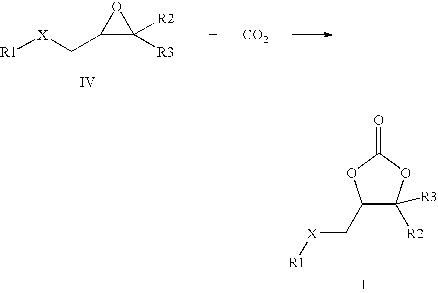

The meanings of the symbols X, R¹, R² and R³ correspond to the meanings given above.

The functionalized epoxides (IV) are produced as mentioned above under a). In the subsequent reaction with CO₂, the epoxide is reacted with carbon dioxide under an increased pressure of, in general, 1 to 50 bar, preferable 1 to 15 bar, and an elevated temperature of, in general, 25 to 150° C., preferably 40 to 120° C. Available catalysts for the reaction are, for example, amines, transition metal-salene complexes, zinc salts or combinations of zinc salts with quaternary ammonium salts. Subsequent work-up and purification of the desired alkylglycidol carbonate are carried out in accordance with methods known to the person skilled in the art.

Alcohols, thiols, alcohol alkoxylates (alcohols reacted with alkylene oxides), amines, carboxylic acids or their esters and carboxamides suitable for the functionalization of the epoxides of the formula III or for the reaction with epichlorohydrin are compounds through which the radical R¹ is added to the epoxide, so that an epoxide of the formula IV or—after hydrolysis—a diol of the formula II is obtained which can be reacted to give the desired alkylglycidol carbonate. Suitable alcohols, amines, carboxylic acids or their esters and carboxamides are listed below.

Alcohols:

Suitable alcohols are linear or branched aliphatic C₃-C₂₉-alcohols, preferably C₅-C₁₈-alcohols. These alcohols have an average degree of branching of from 0 to 2.5, preferably 0.2 to 1.6. The degree of branching is defined here as (number of methyl groups per molecule)-1. Since the aliphatic chain radical of the alcohol joined to the hydroxyl function corresponds to the radical R¹ in the formula I, this last-mentioned radical also has a corresponding degree of branching. The alkyl chain can have further substituents which increase the suitability of the molecule as cosurfactant, but at least do not negatively influence it. Such substituents are known to the person skilled in the art. Preferably, no further substituents are present on the alkyl chain. Examples of alcohols which can be used include butanol, pentanol, hexanol, heptanol, octanol, nonanol, decanol, undecanol, dodecanol, tridecanol, tetradecanol and hexadecanol. Both the unbranched n-form and also branched isomers of all of the abovementioned alcohols can be used. In general, isomeric mixtures of the alcohols employed are used which have the desired average degree of branching.

Alcohols preferably used are C₁₃H₂₇OH, C₁₅H₃₁OH, C₁₀H₂₁OH, C₁₆H₃₃OH, C₁₈H₃₇OH, C₁₂H₂₅OH, C₁₄H₂₉OH, C₈H₁₇OH.

It is also possible to use mixtures of alcohols of different carbon number and to use the alkylglycidol carbonate mixtures produced therefrom as cosurfactants. This embodiment is preferred according to the invention. Particular preference is given here to the use of technical-grade mixtures of alcohols, in particular of mixtures of C₉-/C₁₁-alcohols, C₁₂-/C₁₄-alcohols, C₁₂-/C₁₅-alcohols, C₁₃-/C₁₅-alcohols and/or C₁₆-/C₁₈ alcohols.

The use of so-called Guerbet alcohols and their unsaturated analogs is also preferred according to the invention. These are alcohols with a branch in the 2 position. Examples include 2-ethylhexanol, 2-ethylhex-2-enol, 2-propylhexanol, 2-propylheptanol, 2-propylhept-2-enol, 2-butyloctanol, 2-butyloct-2-enol, 2-pentylnonanol and 2-pentylnon-2-enol. Saturated alcohols are preferred.

In addition, secondary alcohols or mixtures which comprise these alcohols are also suitable. These are obtainable, for example, by one of the following methods:
1. Addition of ketones to aldehydes with subsequent hydrogenation, as described in DE 100 35 617.6. Preference is given to methyl ketones such as acetone, methyl ethyl ketone or methyl isobutyl ketone.
2. Also suitable are paraffin oxidation products which are formed, for example, as a result of Bashkirov oxidation. Preference is given here to products of C₁₁-C₁₅ paraffins, particularly products from C₁₂-C₁₄-paraffins.
3. Addition of water to olefins
4. Free radical or other oxidation of olefins.

The alcohols described here, like the nucleophiles described below, are often not in pure form, but in the form of technical-grade mixtures. Thus, for example when using 2-propylheptanol (C₁₀H₂₁OH), the use of a technical-grade mixture is preferred. In this technical-grade mixture, 2-propylheptanol of the formula C₅H₁₁CH(C₃H₇)CH₂O is in the form of a mixture of at least two isomers, where 70 to 99% by weight of compounds are present in which C₅H₁₁ has the meaning n-C₅H₁₁ and 1 to 30% by weight of compounds are present in which C₅H₁₁ has the meaning C₂H₅CH(CH₃)CH₂ and/or CH₃CH(CH₃)CH₂CH₂.

Thiols:

The alkyl and alkenyl radicals of the suitable thiols correspond to the alkyl and alkenyl radicals of the abovementioned suitable alcohols and alcohol mixtures.

Alcohol Alkoxylates:

Alcohol alkoxylates are the product of the polymerization reaction of alcohols with alkylene oxides, e.g. ethylene oxide, propylene oxide, butylene oxide, pentylene oxide or mixtures thereof.

The alkyl and alkenyl radicals of the alcohols reacted with alkylene oxides likewise correspond to the alkyl and alkenyl radicals of the abovementioned suitable alcohols and alcohol mixtures.

Amines:

Suitable amines are primary (if R⁵ is hydrogen) and secondary amines. The alkyl or alkenyl radical of the amines different than R⁵ likewise corresponds to the alkyl or alkenyl radical of the abovementioned suitable alcohols and alcohol mixtures.

Carboxylic Acids or Carboxylic Esters or Carboxamides:

The alkyl and alkenyl radicals of the carboxylic acids or carboxylic esters or carboxamides likewise correspond to the alkyl and alkenyl radicals of the abovementioned suitable alcohols and alcohol mixtures.

Very particular preference is given to using alcohols.

Particularly preferred alkylglycidol carbonates of the formula I are compounds in which R² and R³ are hydrogen, X is O and R1 is chosen from C₁₃H₂₇, C₁₅H₃₁, C₁₀H₂₁, C₁₆H₃₃, C₁₈H₃₇, C₁₂H₂₅, C₁₄H₂₉, C₈H₁₇, C₉-/C₁₁-alkyl radicals, C₁₂-/C₁₄-alkyl radicals, C₁₂-/C₁₅-alkyl radicals, C₁₃-/C₁₅-alkyl radicals and C₁₆-/C₁₈-alkyl radicals.

Very particular preference is given to alkylglycidol carbonates of the structure I in which R¹=C₅H₁₁CH(C₃H₇)CH₂O and R² and R³═H and X═O. Here, it is even more preferred if the mixture of compounds comprises 70 to 99% by weight of compounds in which C₅H₁₁ has the meaning n-C₅H₁₁ and 1 to 30% by weight of compounds in which C₅H₁₁ has the meaning C₂H₅CH(CH₃)CH₂ and/or CH₃CH(CH₃)CH₂CH₂. Very particular preference is likewise given to alkylglycidol carbonates of the structure I, in which R1 is a technical-grade C₁₃-/C₁₅-alcohol or a native or technical-grade C₁₂-C₁₄-alcohol or a technical-grade C₁₀ or C₁₃-alcohol with a degree of branching of about 1.5, and R² and R³═H and X═O.

Mixtures of two or more of the alkylglycidol carbonates according to the invention are likewise provided by the most preferred embodiment of the present invention.

The invention further provides for the use of the compounds of the formula I as cosurfactant.

The substances of the formula I according to the invention to be used as cosurfactants are suitable for use in industrial, institutional or household detergents and cleaners, and also in the so-called bodycare sector, i.e. body-cleansing and -care compositions.

Further applications are:
humectants, in particular for the printing industry.
cosmetic, pharmaceutical and crop protection formulations. Suitable crop protection formulations are described, for example in EP-A-0 050 228. Further ingredients customary for crop protection compositions may also be present.
paints, coating compositions, inks, pigment preparations and adhesives in the coating and polymer film industry.
leather fat-liquoring compositions.
formulations for the textile industry, such as leveling agents or formulations for yarn cleaning.
fiber processing and auxiliaries for the paper and pulp industry.
metal processing, such as metal refining and electroplating sector.
food industry.
water treatment and drinking water production.
fermentation.
mineral processing and dust control.
building auxiliaries.
emulsion polymerization and preparation of dispersions.
coolants and lubricants.

The detergents are in solid, liquid, gel or paste form. The materials in solid form include powders and compacts, for example granulates and shaped bodies such as tablets.

The detergents comprise 0.1 to 40% by weight, in particular 0.5 to 30% by weight, very particularly 1 to 20% by weight, based on the total amount of the formulation, of at least one substance of the formulae I and/or II. Further constituents are listed below.

Detergent formulations usually comprise ingredients such as surfactants, builders, fragrances and dyes, complexing agents, polymers and other ingredients. Typical formulations are described, for example, in WO 01/32820. Further ingredients suitable for various applications are described in EP-A-0 620 270, WO 95/27034, EP-A-0 681 865, EP-A-0 616 026, EP-A-0 616 028, DE-A-42 37 178 and U.S. Pat. No. 5,340,495, for example.

For the purposes of this invention, detergents are generally used for the washing of materials of greater or lesser flexibility, preferably those which contain or consist of natural, synthetic or semisynthetic fiber materials and which consequently usually have at least partially a textile character. The materials which contain or consist of fibers can, in principle, be in any form which exists in use or for the preparation and processing. For example, fibers may be unarranged in the form of staple or aggregate, arranged in the form of threads, yarns, twines, or in the form of fabrics, such as nonwovens, loden materials or felt, wovens, knits in all conceivable types of weave.

These may be raw fibers or fibers in any stages of processing and may be natural protein or cellulose fibers, such as wool, silk, cotton, sisal, hemp, coconut fibers or synthetic fibers, such as, for example, polyester, polyamide or polyacrylonitrile fibers.

Detergents comprising cosurfactants according to the invention can also be used for cleaning fiber-containing materials, such as e.g. backed carpets with cut or uncut pile.

The compositions of the detergents are preferably adapted to the different purposes, as is familiar to the person skilled in the art from the prior art. For this purpose, all auxiliaries and additives corresponding to the purpose and known from the prior art can be added to the detergents.

In addition to the cosurfactants according to the invention, the following may, for example, be present in detergents:
builders and cobuilders, such as polyphosphates, zeolites, polycarboxylates, phosphonates or complexing agents
ionic surfactants, such as alcohol sulfates/ether sulfates, alkylbenzenesulfonates, α-olefinsulfonates and other alcohol sulfates/ether sulfates
nonionic surfactants, alcohol alkoxyates such as alkylamine alkoxylates, alkyl polyglucosides
optical brighteners
color transfer inhibitors, such as polyvinylpyrrolidone of molar masses 8000 to 70 000, vinylimidazole/vinylpyrrolidone copolymers with a molar ratio of the monomers of from 1:10 to 2:1 and molar masses of from 8000 to 70 000, and poly-4-vinylpyridine N-oxides with molar masses of from 8000 to 70 000
extenders, such as sodium sulfate or magnesium sulfate
soil release agents
incrustation inhibitors
bleaching systems, comprising bleach, such as perborate, percarbonate and bleach activators, such as tetraacetylethylenediamine, and also bleach stabilizers
perfume (oils)
foam suppressors, such as silicone oils
enzymes, such as amylases, lipases, cellulases, proteases
alkali donors, such as soluble alkali metal silicates, e.g. pentasodium methasilicate, sodium carbonate.

Solvents, such as ethanol, isopropanol, 1,2-propylene glycol, butyl glycol etc., can, for example, additionally be used in liquid detergents.

In tablet detergents, it is additionally possible to use tableting auxiliaries, such as polyethylene glycols with molar masses of more than 1000 g/mol, polymer dispersions, and tablet disintegrants, such as cellulose derivatives, crosslinked polyvinylpyrrolidone, crosslinked polyacrylates or combinations of acids, such as citric acid and sodium bicarbonate. A detailed list of possible ingredients is given below.

In some cases, it may be expedient to combine the cosurfactants used according to the invention with other cosurfactants or with amphoteric surfactants, such as, for example, alkylamine oxides, or betaines.

Another class of nonionic surfactants are alkyl polyglucosides having 6 to 22, preferably 10 to 18, carbon atoms in the alkyl chain. These compounds generally contain 1 to 20, preferably 1.1 to 5, glucoside units.

Another class of nonionic surfactants are N-alkylglucamides of the structures 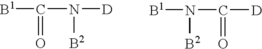
where B¹ is a C₆- to C₂₂-alkyl, B² is hydrogen or C₁- to C₄-alkyl and D is a polyhydroxyalkyl radical having 5 to 12 carbon atoms and at least 3 hydroxyl groups.

Preferably, B¹ is C₁₀- to C₁₈-alkyl, B² is CH₃ and D is a C₅- or C₆-radical. For example, such compounds are obtained by the acylation of reductively aminated sugars with acid chlorides of C₁₀- to C₁₈-carboxylic acids.

Further suitable nonionic surfactants are the terminally capped fatty acid amide alkoxylates, known from WO-A 95/11225, of the formula
R¹—CO—NH—(CH₂)_{y}—O-(A¹O)ₓ—R²
in which

R¹ is a C₅- to C₂₁-alkyl or alkenyl radical,

R² is a C₁- to C₄-alkyl group,

A¹ is C₂- to C₄-alkylene,

y is the number 2 or 3 and

x has a value from 1 to 6.

Examples of such compounds are the reaction products of n-butyltriglycolamine of the formula H₂N—(CH₂—CH₂—O)₃—C₄H₉ with methyl dodecanoate or the reaction products of ethyltetraglycolamine of the formula H₂N—(CH₂—CH₂—O)₄—C₂H₅ with a standard commercial mixture of saturated C₈- to C₁₈-fatty acid methyl esters.

Further suitable nonionic surfactants are also block copolymers of ethylene oxide, propylene oxide and/or butylene oxide (Pluronic® and Tetronic® brands from BASF), polyhydroxy or polyalkoxy fatty acid derivatives, such as polyhydroxy fatty acid amides, N-alkoxy- or N-aryloxypolyhydroxy fatty acid amides, fatty acid amide ethoxylates, in particular terminally capped ones, and fatty acid alkanolamide alkoxylates.

The additional nonionic surfactants are present in the detergents comprising the cosurfactants used in accordance with the invention preferably in an amount of from 0.01 to 30% by weight, in particular 0.1 to 25% by weight, especially 0.5 to 20% by weight.

It is also possible to use individual nonionic surfactants or a combination of different nonionic surfactants. The nonionic surfactants used may come from only one class, in particular only alkoxylated C₈- to C₂₂-alcohols, or surfactant mixtures from different classes can be used.

Suitable anionic surfactants are, for example, fatty alcohol sulfates of fatty alcohols having 8 to 22, preferably 10 to 18, carbon atoms, C₁₂-C₁₈-alcohol sulfates, lauryl sulfate, cetyl sulfate, myristyl sulfate, palmityl sulfate, stearyl sulfate and tallow fatty alcohol sulfate.

Further suitable anionic surfactants are sulfated ethoxylated C₈- to C₂₂-alcohols (alkyl ether sulfates) or soluble salts thereof. Compounds of this type are prepared, for example, by firstly alkoxylating a C₈- to C₂₂-, preferably a C₁₀- to C₁₈-alcohol, e.g. a fatty alcohol, and then sulfating the alkoxylation product. For the alkoxylation, preference is given to using ethylene oxide, 1 to 50 mol, preferably 1 to 20 mol, of ethylene oxide being used per mole of alcohol. The alkoxylation of the alcohols can, however, also be carried out with propylene oxide on its own and optionally butylene oxide. Furthermore, also suitable are those alkoxylated C₈- to C₂₂-alcohols which contain ethylene oxide and propylene oxide or ethylene oxide and butylene oxide or ethylene oxide and propylene oxide and butylene oxide. The alkoxylated C₈- to C₂₂-alcohols can contain the ethylene oxide, propylene oxide and butylene oxide units in the form of blocks or in random distribution. Depending on the nature of the alkoxylation catalyst, alkyl ether sulfates can be obtained with a broad or narrow alkylene oxide homolog distribution.

Further suitable anionic surfactants are alkanesulfonates, such as C₈- to C₂₄-, preferably C₁₀- to C₁₈-alkanesulfonates, and soaps, such as, for example, the Na and K salts of saturated and/or unsaturated C₈- to C₂₄-carboxylic acids.

Further suitable anionic surfactants are linear C₈- to C₂₀-alkylbenzenesulfonates (“LAS”), preferably linear C₉- to C₁₃-alkylbenzenesulfonates and -alkyltoluenesulfonates.

Further suitable anionic surfactants are also C₈- to C₂₄-olefinsulfonates and -disulfonates, which may also represent mixtures of alkene- and hydroxyalkanesulfonates or -disulfonates, alkyl ester sulfonates, sulfonated polycarboxylic acids, alkylglycerol sulfonates, fatty acid glycerol ester sulfonates, alkylphenol polyglycol ether sulfates, paraffinsulfonates having about 20 to about 50 carbon atoms (based on paraffin or paraffin mixtures obtained from natural sources), alkyl phosphates, acyl isethionates, acyl taurates, acyl methyltaurates, alkylsuccinic acids, alkenylsuccinic acids or half-esters or half-amides thereof, alkylsulfosuccinic acids or amides thereof, mono- and diesters of sulfosuccinic acids, acyl sarcosinates, sulfated alkyl polyglucosides, alkyl polyglycol carboxylates and hydroxyalkyl sarcosinates.

The anionic surfactants are preferably added to the detergent in the form of salts. Suitable cations in these salts are alkali metal ions, such as sodium, potassium and lithium and ammonium salts, such as, e.g. hydroxyethylammonium, di(hydroxyethyl)ammonium and tri(hydroxyethyl)ammonium salts.

The anionic surfactants are present in the detergents comprising the cosurfactants according to the invention preferably in an amount of up to 30% by weight, for example from 0.1 to 30% by weight, especially 1 to 25% by weight, in particular 3 to 10% by weight. If C₉ to C₂₀ linear alkylbenzenesulfonates (LAS) are co-used, these are usually employed in an amount up to 15% by weight, in particular up to 10% by weight.

It is possible to use individual anionic surfactants or a combination of different anionic surfactants. The anionic surfactants used may be from only one class, for example only fatty alcohol sulfates or only alkylbenzenesulfonates, although it is also possible to use surfactant mixtures from different classes, e.g. a mixture of fatty alcohol sulfates and alkylbenzenesulfonates.

In addition, the surfactant mixtures comprising the cosurfactants to be used according to the invention can be combined with cationic surfactants, customarily in an amount up to 25% by weight, preferably 1 to 15% by weight, for example C₈- to C₁₆-dialkyldimethylammonium salts, dialkoxydimethylammonium salts or imidazolinium salts with a long-chain alkyl radical; and/or with amphoteric surfactants, customarily in an amount up to 15% by weight, preferably 1 to 10% by weight, for example derivatives of secondary or tertiary amines, such as e.g. C₆-C₁₈-alkylbetaines or C₆-C₁₅-alkylsulfobetaines or alkylamidobetaines or amine oxides, such as alkyldimethylamine oxides.

It is also possible to use cationic surfactants as are described in WO 99/19435.

The mixtures comprising the cosurfactants to be used in accordance with the invention are usually combined with builders (sequestering agents), such as, for example, polyphosphates, polycarboxylates, phosphonates, complexing agents, e.g. methylglycinediacetic acid and salts thereof, nitrilotriacetic acid and salts thereof, ethylenediaminetetraacetic acid and salts thereof, and optionally with cobuilders.

Individual builder substances which are highly suitable for combination with mixtures comprising the cosurfactants to be used in accordance with the invention may be listed below:

Suitable inorganic builders are primarily crystalline or amorphous alumosilicates having ion-exchanging properties, such as, in particular, zeolites. Various types of zeolites are suitable, in particular zeolites A, X, B, P, MAP and HS in their Na form or in forms in which Na is partially replaced by other cations, such as Li, K, Ca, Mg or ammonium. Suitable zeolites are described, for example, in U.S. Pat. No. 4,604,224.

Examples of crystalline silicates which are suitable as builders are disilicates or phyllosilicates, e.g. δ-Na₂Si₂O₅ or β-Na₂Si₂O₅. The silicates can be used in the form of their alkali metal, alkaline earth metal or ammonium salts, preferably as Na, Li and Mg silicates. Amorphous silicates, such as, for example, sodium metasilicate, which has a polymeric structure, or amorphous disilicate can likewise be used.

Suitable carbonate-based inorganic builder substances are carbonates and hydrogencarbonates. These can be used in the form of their alkali metal, alkaline earth metal or ammonium salts. Preference is given to using Na, Li and Mg carbonates or hydrogencarbonates, in particular sodium carbonate and/or sodium hydrogencarbonate.

Customary phosphates used as inorganic builders are alkali metal orthophosphates and/or polyphosphates, such as, for example, pentasodium triphosphate.

Said builder components can be used individually or in mixtures with one another.

In addition, in many cases, it is expedient to add cobuilders to the detergents comprising the cosurfactants to be used in accordance with the invention. Examples of suitable substances are listed below:

In a preferred embodiment, the detergents comprising the cosurfactants to be used in accordance with the invention comprise, in addition to the inorganic builders, 0.05 to 20% by weight, in particular 1 to 10% by weight, of organic cobuilders in the form of low molecular weight, oligomeric or polymeric carboxylic acids, in particular polycarboxylic acids, or phosphonic acids or salts thereof, in particular Na or K salts.

Low molecular weight carboxylic acids or phosphonic acids suitable as organic cobuilders are, for example,

phosphonic acids, such as, for example, 1-hydroxyethane-1,1-diphosphonic acid, amino-tris(methylenephosphonic acid), ethylenediaminetetra(methylenephosphonic acid), hexamethylenediaminetetra(methylenephosphonic acid) and diethylenetriaminepenta(methylenephosphonic acid);

C₄- to C₂₀-di-, -tri- and -tetracarboxylic acids, such as, for example, succinic acid, propanetricarboxylic acid, butanetetracarboxylic acid, cyclopentanetetracarboxylic acid and alkyl- and alkenylsuccinic acids having C₂- to C₁₆-alkyl- or -alkenyl radicals;

C₄- to C₂₀-hydroxycarboxylic acids, such as, for example, malic acid, tartaric acid, gluconic acid, glutaric acid, citric acid, lactobionic acid and sucrose mono-, di- and tricarboxylic acid;

aminopolycarboxylic acids, such as, for example, nitrilotriacetic acid, β-alaninediacetic acid, ethylenediaminetetraacetic acid, serinediacetic acid, isoserinediacetic acid, alkylethylenediaminetriacetates, N,N-bis(carboxymethyl)glutamic acid, ethylenediamine-disuccinic acid and N-(2-hydroxyethyl)iminodiacetic acid, methyl- and ethylglycinediacetic acid.

Examples of oligomeric or polymeric carboxylic acids which are suitable as organic cobuilders are:

oligomaleic acids, as are described, for example, in EP-A 451508 and EP-A 396303;

co- and terpolymers of unsaturated C₄- to C₈-dicarboxylic acids, the copolymerized comonomers being monoethylenically unsaturated monomers from group (i), given below, in amounts of up to 95% by weight, from group (ii) in amounts of up to 60% by weight and from group (iii) in amounts of up to 20% by weight.

Examples of unsaturated C₄- to C₈-dicarboxylic acids in this context are maleic acid, fumaric acid, itaconic acid and citraconic acid. Preference is given to maleic acid.

Group (i) includes monoethylenically unsaturated C₃-C₈-monocarboxylic acids, such as, for example, acrylic acid, methacrylic acid, crotonic acid and vinylacetic acid. From group (i), preference is given to using acrylic acid and methacrylic acid.

Group (ii) includes monoethylenically unsaturated C₂- to C₂₂-olefins, vinyl alkyl ethers having C₁- to C₈-alkyl groups, styrene, vinyl esters of C₁- to C₈-carboxylic acids, (meth)acrylamide and vinylpyrrolidone. From group (ii), preference is given to using C₂- to C₆-olefins, vinyl alkyl ethers having C₁- to C₄-alkyl groups, vinyl acetate and vinyl propionate.

If the polymers of group (ii) contain copolymerized vinyl esters, some or all of the latter can also be present in hydrolyzed form to give vinyl alcohol structural units. Suitable co- and terpolymers are known, for example, from U.S. Pat. No. 3,887,806 and DE-A 4313909.

Group (iii) includes (meth)acrylic esters of C₁- to C₈-alcohols, (meth)acrylonitrile, (meth)acrylamides of C₁- to C₈-amines, N-vinylformamide and N-vinylimidazole.

Also suitable as organic cobuilders are homopolymers of monoethylenically unsaturated C₃-C₈-monocarboxylic acids, such as, for example, acrylic acid, methacrylic acid, crotonic acid and vinylacetic acid, in particular acrylic acid and methacrylic acid;

copolymers of dicarboxylic acids, such as, for example, copolymers of maleic acid and acrylic acid in the weight ratio 10:90 to 95:5, particularly preferably those in the weight ratio 30:70 to 90:10 with molar masses of from 1000 to 150 000;

terpolymers of maleic acid, acrylic acid and a vinyl ester of a C₁-C₃-carboxylic acid in the weight ratio 10 (maleic acid):90 (acrylic acid+vinyl ester) to 95 (maleic acid):10 (acrylic acid+vinyl ester), where the weight ratio of acrylic acid to the vinyl ester can vary within the range from 30:70 to 70:30;

copolymers of maleic acid with C₂-C₈-olefins in the molar ratio 40:60 to 80:20, copolymers of maleic acid with ethylene, propylene or isobutene in the molar ratio 50:50 being particularly preferred.

Graft polymers of unsaturated carboxylic acids onto low molecular weight carbohydrates or hydrogenated carbohydrates, cf. U.S. Pat. No. 5,227,446, DE-A 44 15 623 and DE-A 43 13 909, are likewise suitable as organic cobuilders.

Examples of suitable unsaturated carboxylic acids in this context are maleic acid, fumaric acid, itaconic acid, citraconic acid, acrylic acid, methacrylic acid, crotonic acid and vinylacetic acid, and also mixtures of acrylic acid and maleic acid which are grafted on in amounts of from 40 to 95% by weight, based on the component to be grafted.

For modification, it is additionally possible for up to 30% by weight, based on the component to be grafted, of further monoethylenically unsaturated monomers to be present in copolymerized form. Suitable modifying monomers are the abovementioned monomers of groups (ii) and (iii).

Suitable graft bases are degraded polysaccharides, such as, for example, acidically or enzymatically degraded starches, inulins or cellulose, protein hydrolyzates and reduced (hydrogenated or reductively aminated) degraded polysaccharides, such as, for example, mannitol, sorbitol, aminosorbitol and N-alkylglucamine, and also polyalkylene glycols with molar masses up to M_{w}=5000, such as, for example, polyethylene glycols, ethylene oxide/propylene oxide or ethylene oxide/butylene oxide or ethylene oxide/propylene oxide/butylene oxide block copolymers and alkoxylated mono- or polyhydric C₁- to C₂₂-alcohols (cf. U.S. Pat. No. 5,756,456).

Polyglyoxylic acids suitable as organic cobuilders are described, for example, in EP-B-001 004, U.S. Pat. No. 5,399,286, DE-A-41 06 355 and EP-A-656 914. The end groups of the polyglyoxylic acids may have different structures.

Polyamidocarboxylic acids and modified polyamidocarboxylic acids suitable as organic cobuilders are known, for example, from EP-A-454126, EP-B-511037, WO-A-94/01486 and EP-A-581452.

In particular, polyaspartic acids or cocondensates of aspartic acid with further amino acids, C₄- to C₂₅-mono- or -dicarboxylic acids and/or C₄- to C₂₅-mono- or -diamines are also used as organic cobuilders. Particular preference is given to using polyaspartic acids which have been produced in phosphorus-containing acids and modified with C₆- to C₂₂-mono- or -dicarboxylic acids or with C₆- to C₂₂-mono- or -diamines.

Also suitable as organic cobuilders are iminodisuccinic acid, oxydisuccinic acid, aminopolycarboxylates, alkylpolyaminocarboxylates, aminopolyalkylenephosphonates, polyglutamates, hydrophobically modified citric acid, such as, for example, agaric acid, poly-α-hydroxyacrylic acid, N-acylethylenediaminetriacetates, such as lauroyl ethylenediaminetriacetate and alkylamides of ethylenediaminetetraacetic acid, such as EDTA-tallow amide.

Furthermore, it is also possible to use oxidized starches as organic cobuilders.

Further suitable (co)builders are described in WO 99/19435.

In a further preferred embodiment, the detergents comprising the cosurfactants to be used in accordance with the invention additionally comprise, in particular in addition to the inorganic builders, the anionic surfactants and/or the nonionic surfactants, 0.5 to 20% by weight, in particular 1 to 10% by weight, of glycine-N,N-diacetic acid derivatives, as described in WO 97/19159.

It is also frequently expedient to add bleaching systems, consisting of bleaches, such as, for example, perborate, percarbonate, and optionally bleach activators, such as, for example, tetraacetylethylenediamine, +bleach stabilizers and optionally bleach catalysts to the detergents comprising the cosurfactants to be used in accordance with the invention.

In these cases, the detergents comprising the cosurfactants to be used in accordance with the invention additionally comprise 0.5 to 30% by weight, in particular 5 to 27% by weight, especially 10 to 23% by weight, of bleaches in the form of percarboxylic acids, e.g. diperoxododecanedicarboxylic acid, phthalimidopercaproic acid, or monoperoxophthalic acid or -terephthalic acid, adducts of hydrogen peroxide with inorganic salts, e.g. sodium perborate monohydrate, sodium perborate tetrahydrate, sodium carbonate perhydrate or sodium phosphate perhydrate, adducts of hydrogen peroxide with organic compounds, e.g. urea perhydrate, or of inorganic peroxo salts, e.g. alkali metal persulfates or peroxodisulfates, optionally in combination with 0 to 15% by weight, preferably 0.1 to 15% by weight, in particular 0.5 to 8% by weight, of bleach activators.

Suitable bleach activators are:
polyacylated sugars, e.g. pentaacetylglucose;
acyloxybenzenesulfonic acids and alkali metal and alkaline earth metal salts thereof, e.g. sodium p-nonanoyloxybenzenesulfonate or sodium p-benzoyloxybenzenesulfonate;
N,N-diacylated and N,N,N′,N′-tetraacylated amines, e.g. N,N,N′,N′-tetraacetyl-methylenediamine and -ethylenediamine (TAED), N,N-diacetylaniline, N,N-diacetyl-p-toluidine or 1,3-diacylated hydantoins, such as 1,3-diacetyl-5,5-dimethylhydantoin;
N-alkyl-N-sulfonylcarboxamides, e.g. N-methyl-N-mesylacetamide or N-methyl-N-mesylbenzamide;
N-acylated cyclic hydrazides, acylated triazoles or urazoles, e.g. monoacetylmaleic hydrazide;
O,N,N-trisubstituted hydroxylamines, e.g. O-benzoyl-N,N-succinylhydroxylamine, O-acetyl-N,N-succinylhydroxylamine or O,N,N-triacetylhydroxylamine;
N,N′-diacylsulfurylamides, e.g. N,N′-dimethyl-N,N′-diacetylsulfurylamide or N,N′-diethyl-N,N′-dipropionylsulfurylamide;
acylated lactams, such as, for example, acetylcaprolactam, octanoylcaprolactam, benzoylcaprolactam or carbonylbiscaprolactam;
anthranil derivatives, such as, for example, 2-methylanthranil or 2-phenylanthranil;
triacyl cyanurates, e.g. triacetyl cyanurate or tribenzoyl cyanurate;
oxime esters and bisoxime esters, such as, for example, O-acetylacetone oxime or bisisopropyliminocarbonate;
carboxylic anhydrides, e.g. acetic anhydride, benzoic anhydride, m-chlorobenzoic anhydride or phthalic anhydride;
enol esters, such as, for example, isopropenyl acetate;
1,3-diacyl-4,5-diacyloxyimidazolines, e.g. 1,3-diacetyl-4,5-diacetoxyimidazoline;
tetraacetylglycoluril and tetrapropionylglycoluril;
diacylated 2,5-diketopiperazines, e.g. 1,4-diacetyl-2,5-diketopiperazine;
ammonium-substituted nitriles, such as, for example, N-methylmorpholinium acetonitrile methylsulfate;
acylation products of propylenediurea and 2,2-dimethylpropylenediurea, e.g. tetraacetylpropylenediurea;
α-acyloxypolyacylmalonamides, e.g. α-acetoxy-N,N′-diacetylmalonamide;
diacyldioxohexahydro-1,3,5-triazines, e.g. 1,5-diacetyl-2,4-dioxohexahydro-1,3,5-triazine;
benz-(4H)1,3-oxazin-4-ones having alkyl radicals, e.g. methyl, or aromatic radicals, e.g. phenyl, in the 2-position;
cationic nitriles, as described in DE-A-101 48 577.

The described bleaching system comprising bleaches and bleach activators can optionally also comprise bleach catalysts. Examples of suitable bleach catalysts are quaternized imines and sulfonimines, which are described, for example, in U.S. Pat. No. 5,360,569 and EP-A 453 003. Particularly effective bleach catalysts are manganese complexes, which are described, for example, in WO-A 94/21777. Where used, such compounds are incorporated into the detergents in amounts of at most up to 1.5% by weight, in particular up to 0.5% by weight, and in the case of very active manganese complexes, in amounts up to 0.1% by weight. Further suitable bleach catalysts are described in WO 99/19435.

Further bleaching systems based on arylimidoperalkanoic acids which can be used are described in EP-A-0 325 288 and EP-A-0 490 409.

Bleach Stabilizer

These are additives which are able to absorb, bind or complex traces of heavy metals. Examples of additives with a bleach-stabilizing action which can be used according to the invention are polyanionic compounds, such as polyphosphates, polycarboxylates, polyhydroxypolycarboxylates, soluble silicates as completely or partially neutralized alkali metal or alkaline earth metal salts, in particular as neutral Na or Mg salts which are relatively weak bleach stabilizers. Strong bleach stabilizers which can be used according to the invention are, for example, complexing agents, such as ethylenediamine tetraacetate (EDTA), nitrilotriacetic acid (NTA), methylglycinediacetic acid (MGDA), β-alaninediacetic acid (ADA), ethylenediamine N,N′-disuccinate (EDDS) and phosphonates, such as ethylenediaminetetramethylenephosphonate, diethylenetriaminepentamethylenephosphonate or hydroxyethylidene-1,1-diphosphonic acid in the form of the acids or as partially or completely neutralized alkali metal salts. The complexing agents are preferably used in the form of their Na salts.

As well as the described bleaching system comprising bleaches, bleach activators and optionally bleach catalysts, the use of systems with enzymatic peroxide release or of photoactivated bleaching systems is also possible for the detergents comprising the cosurfactants to be used in accordance with the invention, see e.g. U.S. Pat. No. 4,033,718.

For a number of uses, it is expedient for the detergents comprising the cosurfactants to be used in accordance with the invention to comprise enzymes. Enzymes which are preferably used in detergents are proteases, amylases, lipases and cellulases. Preferred amounts of the enzymes are from 0.1 to 1.5% by weight, particularly preferably 0.2 to 1.0% by weight, of the formulated enzyme. Examples of suitable proteases are Savinase and Esperase. A suitable lipase is e.g. Lipolase. A suitable cellulase is e.g. Celluzym. The use of peroxidases for activating the bleaching system is also possible. It is possible to use individual enzymes or a combination of different enzymes. Where appropriate, the detergent comprising the cosurfactants to be used in accordance with the invention can also comprise enzyme stabilizers, e.g. calcium propionate, sodium formate or boric acids or salts thereof, and/or antioxidants.

The constituents of detergents are known in principle to the person skilled in the art. The lists, above and below, of suitable constituents give merely an illustrative selection of the known suitable constituents.

In addition to the main components stated hitherto, the detergents comprising the cosurfactants to be used in accordance with the invention can also comprise the following further customary additives in the amounts customary for this purpose:

Known dispersants, such as naphthalenesulfonic acid condensates or polycarboxylates, soil-carrying agents, soil release agents, such as polyether esters, incrustation inhibitors, pH-regulating compounds, such as alkalis or alkali donors (NaOH, KOH, pentasodium metasilicate, sodium carbonate) or acids (hydrochloric acid, phosphoric acid, amidosulfuric acid, citric acid), buffer systems, such as acetate or phosphate buffer, ion exchangers, perfume, dyes, graying inhibitors, optical (fluorescent) brighteners, color-transfer inhibitors, such as, for example, polyvinylpyrrolidone, biocides, such as isothiazolinones or 2-bromo-2-nitro-1,3-propanediol, hydrotropic compounds as solubility promoters or solubilizers, such as cumenesulfonates, toluenesulfonates, short-chain fatty acids, urea, alcohols or phosphoric alkyl/aryl esters, foam regulators for stabilizing or suppressing foam, e.g. silicone oils, skin and corrosion protectants, disinfecting compounds or systems, such as, for example, those which release chlorine or hypochlorous acid, such as dichloroisocyanurate or which contain iodine, thickeners and extenders and formulating agents.

Graying Inhibitors and Soil Release Polymers

Suitable soil release polymers and/or graying inhibitors for detergents are for example:

polyesters of polyethylene oxides with ethylene glycol and/or propylene glycol and aromatic dicarboxylic acids or aromatic and aliphatic dicarboxylic acids;

polyesters of unilaterally terminally capped polyethylene oxides with di- and/or polyhydric alcohols and dicarboxylic acid.

Such polyesters are known, for example from U.S. Pat. No. 3,557,039, GB-A 1 154730, EP-A-185 427, EP-A-241 984, EP-A-241 985, EP-A-272 033 and U.S. Pat. No. 5,142,020.

Further suitable soil release polymers are amphiphilic graft or copolymers of vinyl and/or acrylic esters onto polyalkylene oxides (cf. U.S. Pat. No. 4,746,456, U.S. Pat. No. 4,846,995, DE-A-37 11 299, U.S. Pat. No. 4,904,408, U.S. Pat. No. 4,846,994 and U.S. Pat. No. 4,849,126) or modified celluloses, such as, for example, methylcellulose, hydroxypropylcellulose or carboxymethylcellulose.

Color Transfer Inhibitors

The color transfer inhibitors used are, for example, homo- and copolymers of vinylpyrrolidone, of vinylimidazole, of vinyloxazolidone and of 4-vinylpyridine N-oxide having molar masses of from 15 000 to 100 000, and crosslinked finely divided polymers based on these monomers. The use mentioned here of such polymers is known, cf. DE-B-22 32 353, DE-A-28 14 287, DE-A-28 14 329 and DE-A43 16 023.

Suitable polyvinylpyridinebetaines are described, for example in Tai, Formulating Detergents and Personal Care Products, AOCS Press, 2000, page 113.

In addition to the use in detergents and cleaners for domestic textile washing, the detergent compositions which can be used according to the invention can also be used in the field of commercial textile washing and of commercial cleaning. In this field of use, peracetic acid is usually used as bleach, and is added to the wash liquor as an aqueous solution.

Use in Textile Detergents

A typical pulverulent or granular heavy-duty detergent according to the invention may, for example, have the following composition:
0.5 to 50% by weight, preferably 5 to 30% by weight, of at least one anionic and/or nonionic surfactant, including at least one cosurfactant according to the invention,
0.5 to 60% by weight, preferably 15 to 40% by weight, of at least one inorganic builder,
0 to 20% by weight, preferably 0.5 to 8% by weight, of at least one organic cobuilder,
2 to 35% by weight, preferably 5 to 30% by weight, of an inorganic bleach,
0.1 to 20% by weight, preferably 0.5 to 10% by weight, of a bleach activator, optionally in a mixture with further bleach activators,
0 to 1% by weight, preferably up to at most 0.5% by weight, of a bleach catalyst,
0 to 5% by weight, preferably 0 to 2.5%, of a polymeric color transfer inhibitor,
0 to 1.5% by weight, preferably 0.1 to 1.0% by weight, of protease,
0 to 1.5% by weight, preferably 0.1 to 1.0% by weight, of lipase,
0 to 1.5% by weight, preferably 0.2 to 1.0% by weight, of a soil release polymer,

ad 100% of customary auxiliaries and adjuncts and water.

Inorganic builders preferably used in detergents are sodium carbonate, sodium hydrogencarbonate, zeolite A and P, and amorphous and crystalline Na silicates, and also phyllosilicates.

Organic cobuilders preferably used in detergents are acrylic acid/maleic acid copolymers, acrylic acid/maleic acid/vinyl ester terpolymers and citric acid.

Inorganic bleaches preferably used in detergents are sodium perborate and sodium carbonate perhydrate.

Anionic surfactants preferably used in detergents are linear and slightly branched alkylbenzenesulfonates (LAS), fatty alcohol sulfates/ether sulfates and soaps.

Enzymes preferably used in detergents are protease, lipase, amylase and cellulase. For the commercially available enzymes, amounts of from 0.05 to 2.0% by weight, preferably 0.2 to 1.5% by weight, of the formulated enzyme, are generally added to the detergent. Suitable proteases are, for example, Savinase, Desazym and Esperase. A suitable lipase is, for example, Lipolase. A suitable cellulase is, for example, Celluzym.

Soil release polymers and graying inhibitors preferably used in detergents are graft polymers of vinyl acetate onto polyethylene oxide of molar mass 2500-8000 in the weight ratio 1.2:1 to 3.0:1, polyethylene terephthalates/oxyethylene terephthalates of molar mass 3000 to 25 000 from polyethylene oxides of molar mass 750 to 5000 with terephthalic acid and ethylene oxide and a molar ratio of polyethylene terephthalate to polyoxyethylene terephthalate of from 8:1 to 1:1, and block polycondensates according to DE-A-44 03 866.

Color transfer inhibitors preferably used in detergents are soluble NVP homopolymers and/or vinylpyrrolidone and vinylimidazole copolymers with molar masses greater than 5000.

The detergents are often in solid, pulverulent form, in which case they usually additionally comprise customary extenders, which give them good flowability, dosability and solubility and which prevent caking and dusting, such as sodium sulfate or magnesium sulfate.

Pulverulent or granular detergents comprising the cosurfactants to be used in accordance with the invention can comprise up to 60% by weight of inorganic extenders. However, these detergents preferably have a low content of extenders and comprise only up to 20% by weight, particularly preferably only up to 8% by weight, of extenders.

Detergents comprising the cosurfactants to be used in accordance with the invention can have various bulk densities in the range from 300 to 1200, in particular 500 to 950 g/l. Modern compact detergents usually have high bulk densities and are granular in structure. Compact or ultracompact detergents and extrudates have a bulk density of >600 g/l. These are becoming ever more important.

If they are to be used in liquid form, they may be in the form of aqueous microemulsions, emulsions or solutions. In liquid detergents, solvents such as ethanol, isopropanol, 1,2-propylene glycol or butyl glycol can additionally be used.

In the case of gel detergents, thickeners, such as, for example, polysaccharides and/or weakly crosslinked polycarboxylates (for example Carbopol® from Goodrich) can additionally be used.

In the case of tablet detergents, tableting auxiliaries, such as, for example, polyethylene glycols with molar masses of >1000 g/mol, polymer dispersions, and tablet disintegrants such as cellulose derivatives, crosslinked polyvinylpyrrolidone, crosslinked polyacrylates or combinations of acids, e.g. citric acid+sodium bicarbonate, to name but a few, are additionally required.

The present invention further provides for the use of the mixtures in the preparation of detergents.

In connection with the present invention, the term “household cleaners” or “cleaners” are generally understood as meaning formulations which are used for cleaning hard surfaces. They are in liquid, gel, paste or solid form. Materials which are in solid form include powders and compacts, such as, for example, granulates and shaped bodies, for example tablets. Examples include hand dishwashing detergents, machine dishwashing detergents, metal degreasers, glass cleaners, floor cleaners, all-purpose cleaners, high-pressure cleaners, alkaline cleaners, acidic cleaners, spray degreasers, dairy cleaners, upholstery cleaners, plastics cleaners and bath cleaners. They comprise 0.01 to 40% by weight, preferably 0.1 to 25% by weight, based on the total formulation, of at least one substance of the formulae I and/or II. Further constituents are detailed below.
ionic surfactants, such as, for example, alcohol sulfate/ether sulfates, alkylbenzenesulfonates, α-olefinsulfonates, sulfosuccinates, as described above under “detergents”.
nonionic surfactants, such as, for example, alcohol alkoxylates, alkylamine alkoxylates, alkylamide ethoxylates, alkyl polyglucosides, as described above under “detergents”.
amphoteric surfactants, such as, for example, alkylamine oxides, betaines, as described above under “detergents”.
builders, such as, for example, polyphosphates, polycarboxylates, phosphonates, complexing agents, e.g. methylglycinediacetic acid and salts thereof, nitrilotriacetic acid and salts thereof, ethylenediaminetetraacetic acid and salts thereof, as described above under “detergents”.
dispersants, such as, for example, naphthalenesulfonic acid condensates, polycarboxylates, as described above under “detergents”.
pH-regulating compounds, such as, for example, alkalis (NaOH, KOH, pentasodium metasilicate) or acids (hydrochloric acid, phosphoric acid, amidosulfuric acid, citric acid)
enzymes, such as, for example, lipases, amylases, proteases
perfume
dyes
biocides, such as, for example, isothiazolinones, 2-bromo-2-nitro-1,3-propanediol, as described above under “detergents”.
bleaching systems, consisting of bleaches, such as, for example, perborate, percarbonate etc., plus bleach activators, such as, for example, tetraacetylethylenediamine, plus bleach stabilizers, as described above under “detergents”.
Solubilizers, such as, for example, cumenesulfonates, toluenesulfonates, short-chain fatty acids, phosphoric alkyl/aryl esters
solvents, such as, for example, short-chain alkyl oligoglycols, such as butyl glycol, butyl diglycol, propylene glycol monomethyl ether, alcohols, such as ethanol, isopropanol, aromatic solvents, such as toluene, xylene, N-alkylpyrrolidones, alkylene carbonates.

The constituents of cleaners for hard surfaces are known in principle to the person skilled in the art. The above list represents merely an exemplary section of the constituents.

The cleaners for hard surfaces are usually, but not exclusively, aqueous and are in the form of microemulsions, emulsions or solutions.

Where they are present in solid, pulverulent form, extenders, such as, for example, sodium sulfate, magnesium sulfate, etc. may additionally be used.

In the case of cleaners in the form of tablets, tableting auxiliaries, such as, for example, polyethylene glycols with molar masses >1000 g/mol, polymer dispersions etc., and tablet disintegrants, such as, for example, cellulose derivatives, crosslinked polyvinylpyrrolidone, crosslinked polyacrylates or combinations of acids, e.g. citric acid plus sodium bicarbonate, to name but a few, are additionally required.

In a particularly preferred embodiment of the present application, the cleaners are hand dishwashing detergents. The present application therefore further provides a hand dishwashing detergent comprising at least one alkylglycidol carbonate of the formula I as cosurfactant, and also for the use of the alkylglycidol carbonates of the formula I as cosurfactants in hand dishwashing detergents.

Products from the bodycare sector are, for example, shampoos, shower and bath gels, shower and bath lotions, lipsticks and cosmetic formulations with care and/or conditioning properties, such as styling products. Examples are hair foams, hair gels, hair sprays or after-treatment compositions, such as hair tonics, lotions, treatment rinses, treatment packs, split-end fluids, hair repair compositions, “hot oil treatments”, shampoos, liquid soaps, care creams, hair-setting compositions, hair colorants and permanent waving compositions. When used in bodycare products, the substances of the formula I have the advantage that the physiological irritancy of the surfactant mixtures is ameliorated and the mucous membranes are protected.

The invention will now be illustrated in the examples below.

### EXAMPLE 1

### Preparation of 2-propylheptylglycidol carbonate

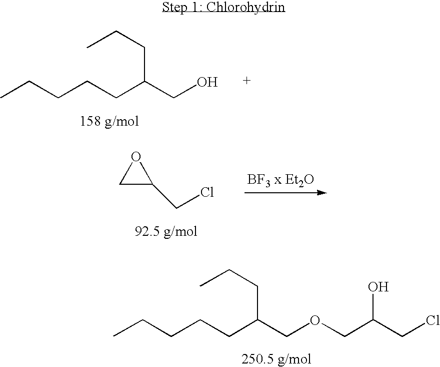

316 g (2 mol) of 2-propylheptanol were initially introduced together with 1 g of BF₃-diethyl etherate complex at room temperature. The mixture was heated to 50° C. and, over the course of 4 hours, 186 g (2 mol) of epichlorohydrin were metered in. The mixture was after-stirred for a further 30 min at 50° C. and then left to cool to room temperature. Following analysis (GC/MS), the expected product was the main product (about 60%) of the synthesis. Purification by distillation is possible.

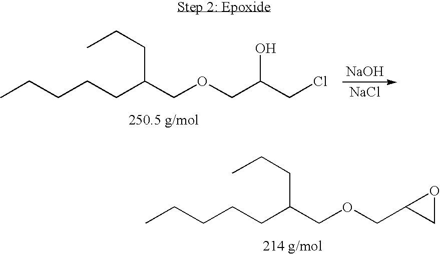

159 g (1.0 mol) of 25% NaOH (in water) were carefully added dropwise at room temperature to 125.3 g (0.5 mol) of chlorohydrin. During this addition, the mixture was slowly heated to 50° C. When the addition was complete, the mixture was heated further to 100° C. and stirred at this temperature for 15 hours. After the mixture had cooled to room temperature, the two phases were separated. The upper phase comprised the desired product, which could be purified by distillation. Yield: 99%.

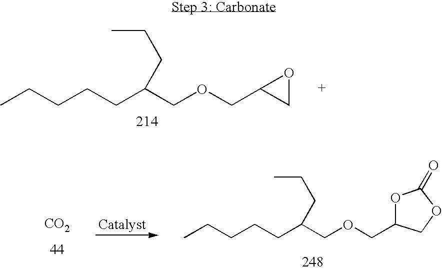

The epoxide (40 g, 0.15 mol) was initially introduced together with a catalyst (0.42 g) into acetone at room temperature. Catalysts for the carbonate formation are described, for example, in: Paddock, Nguyen, J. Am. Chem. Soc. 2001, 123, 11498; Kisch, Millini, Wang, Chem. Ber. 1986, 119 (3), 1090; Baba, Nozaki, Matsuda, Bull. Chem. Soc. Jpn. 1987, 60 (4), 1552; Lermontov, Velikokhat'ko, Zavorin, Russ. Chem. Bull. 1998, 47 (7), 1405; Rokicki, Kuran, Pogorzelska-Marciniak, Monatshefte für Chemie 1984, 115, 205. The mixture was heated to 110° C. in a pressure autoclave, and CO₂ was injected to a pressure of 14 bar. This pressure was maintained for 11 hours, then the system was left to cool to 50° C. and decompressed. All of the volatile components were separated off on a rotary evaporator and the desired product was obtained as the distillation bottom-product.

### EXAMPLE 2

Hand Dishwashing Detergent

A model formulation comprising 30% by weight of Lutensit® ALBN50 (BASF AG, alkylbenzenesulfnoate, 50% strength), 10% by weight of Lutensol® AO7 (BASF AG, C13/15-alcohol ethoxylate, 7 ethylene oxide, 100% strength), 3% by weight of 2-propylheptylglycidol carbonate is admixed with various amounts of Lutensol® A3N (BASF AG, C12,14-alcohol ethoxylate, 3EO, 100% strength, BASF AG). The resulting mixtures are analyzed using an Uhbelohde viscometer, spindle 3, shear rate 3 s-1. In parallel experiments, a corresponding surfactant mixture in which the reaction product has been replaced by Mazox®LDA (laurylamine oxide, 100% strength, origin BASF Corporation) and by water, were investigated. The results are summarized in the table. The viscosity increase is most marked for the product according to the invention.

| 0 | 1 | 2 | 4 | 6 | 8 | % Lutensol ® A3N |
|---|---|---|---|---|---|---|
| 3040 | 3440 | 8200 | 12300 | 18000 | 52000 | 2-propylheptyl- |
| | | | | | | glycidol carbonate |
| 1210 | 905 | 970 | 1820 | 2890 | 7010 | Water |
| 2040 | 2500 | 2910 | 5760 | 12700 | 19200 | Mazox LDA |
| | | | | | | oxides w.s. |

### EXAMPLE 3

Hand Dishwashing Detergent

Foam Stabilization with 2-propylheptylglycidol carbonate

A model formulation comprising 30% by weight of Lutensit® ALBN50 (alkylbenzenesulfonate, 50% strength), 10% by weight of Lutensol(® AO7 (C13/15-alcohol ethoxylate, 7 ethylene oxide, 100% strength), 3% by weight of 2-propylheptylglycidol carbonate and 3% by weight of Lutensol A3N (C12,14-alcohol ethoxylate, 3EO, 100% strength) is diluted to 2% by weight of surfactant. In a beaker (5 l in volume, filled to 2 l), this surfactant solution is foamed by stirring. When a stable state is established, fresh olive oil is added dropwise until the foam has disappeared. The amount of oil required for this purpose is a measure of the stability of the foam. [lacuna] parallel experiments a corresponding surfactant mixture in which the reaction product was replaced by Mazox®LDA (laurylamine oxide, 100% strength) and by water were investigated. The results are summarized in the table.

| Additive | Consumption of olive oil |
|---|---|
| Propylheptylglycidol carbonate | 46 ml |
| Mazox ®LDA | 28 ml |
| Water | 27 ml |

1-20. (canceled)

21. A compound comprising an alkylglycidol carbonate of the formula I 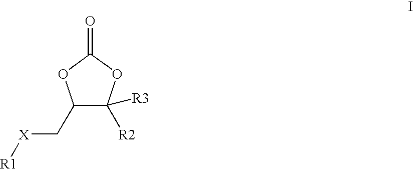
in which the symbols X, R¹, R² and R³ have the following meanings:
R¹ is a linear or branched, unsubstituted C₃-C₂₉-alkyl group or a linear or branched, unsubstituted C₃-C₂₉-alkenyl group, wherein the substituent R¹ has an average degree of branching which is defined as (number of methyl groups per molecule)-1 of from 0.2 to 1.6;
R² and R³, independently of one another, are hydrogen or a linear or branched alkyl group;
X is selected from the group consisting of O, O(CH₂CHR⁴O)ₙ, S, NR⁵, COO and CONH, in which R⁴ and R⁵ are hydrogen, methyl, ethyl or propyl, and n is a number from 1 to 5, where mixtures of compounds with groups X of the formula O(CH₂CHR⁴O)ₙ are also included by the formula I, in which n has various numerical values,
wherein alkylglycidol carbonates of formula 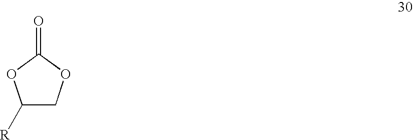
wherein R is CH₂—O—CH(CH₃)₂ are excluded.

22. The compound as claimed in claim 21, wherein in formula I the symbols X, R¹, R² and R³ have the following meanings:
R¹ is a linear or branched C₃-C₁₈-alkyl group or a linear or branched C₃-C₁₈-alkenyl group, wherein the substituent R¹ has an average degree of branching of from 0.2 to 1.6;
R² and R³, independently of one another are hydrogen or a linear or branched alkyl group having 1 to 5 carbon atoms; and
X is O, O(CH₂CHR⁴O)ₙ or NR⁵, in which R⁴ and R⁵ are hydrogen, methyl, ethyl or propyl and n is a number from 1 to 5, where mixtures of compounds with groups X of the formula O(CH₂CHR⁴O)ₙ are covered by the formula I, in which n can have various numerical values.

23. The compound as claimed in claim 21, wherein
R¹ is a linear or branched C₅-C₁₈-alkyl group or a linear or branched C₅-C₁₈-alkenyl, wherein the substituent has an average degree of branching of from 0.2 to 1.6; and
at least one of the radicals R² or R³ is hydrogen.

24. The compound as claimed in claim 21, wherein R² and R³ are hydrogen.

25. The compound as claimed in claim 24, wherein R¹—X is C₅H₁₁CH(C₃H₇)CH₂O, or a radical based on a technical-grade C₁₃-C₁₅-oxo alcohol or a technical-grade or native C₁₂-C₁₄-alcohol or a C₁₀- or C₁₃-alcohol and having a degree of branching of about 1.5.

26. The compound as claimed in claim 25, in which R¹−X is C₅H₁₁CH(C₃H₇)CH₂O, and which are present as a mixture, in which
70 to 99% by weight of compounds in which C₅H₁₁ has the meaning n-C₅H₁₁ are present and
1 to 30% by weight of compounds in which C₅H₁₁ has the meaning C₂H₅CH(CH₃)CH₂ and/or CH₃CH(CH₃)CH₂CH₂ are present.

27. A compound comprising an alkylglycidol carbonate of the formula I 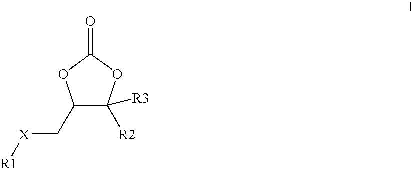
in which the symbols X, R¹, R² and R³ have the following meanings:
R¹ is a linear or branched, unsubstituted C₃-C₂₉-alkyl group or a linear or branched, unsubstituted C₃-C₂₉-alkenyl group;
R² and R³, independently of one another, are hydrogen or a linear or branched alkyl group;
X is chosen from the group consisting of O(CH₂CHR4O)ₙ, S, NR⁵ and CONH, in which R⁴ and R⁵ are hydrogen, methyl, ethyl or propyl, and n is a number from 1 to 5, where mixtures of compounds with groups X of the formula O(CH₂CHR₄O)ₙ are also included by the formula I, in which n has various numerical values.

28. The compound as claimed in claim 27, wherein the substituent R¹ has an average degree of branching which is defined as (number of methyl groups per molecule)-1 of from 0 to 2.5.

29. A method for producing an alkylglycidol carbonate as claimed in claim 21, comprising reacting 1,2-diols of the formula II and functionalized with an R¹—X—CH₂ group with phosgene in accordance with the following reaction scheme: 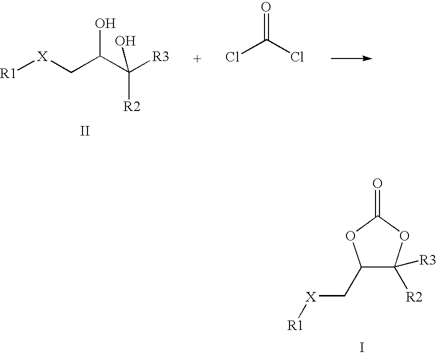
in which the symbols X, R¹, R² and R³ have the following meanings:
R¹ is a linear or branched, unsubstituted C₃-C₂₉-alkyl group or a linear or branched, unsubstituted C₃-C₂₉-alkenyl group;
R² and R³, independently of one another, are hydrogen or a linear or branched alkyl group;
X is selected from the group consisting of O, O(CH₂CHR⁴O)ₙ, S, NR⁵, COO and CONH, in which R⁴ and R⁵ are hydrogen, methyl, ethyl or propyl, and n is a number from 1 to 5, where mixtures of compounds with groups X of the formula O(CH₂CHR⁴O)ₙ are also included by the formula I, in which n has various numerical values.

30. A method for producing an alkylglycidol carbonate as claimed in claim 21, comprising reacting epoxides of the formula IV according to the following reaction scheme with CO₂ using a catalyst: 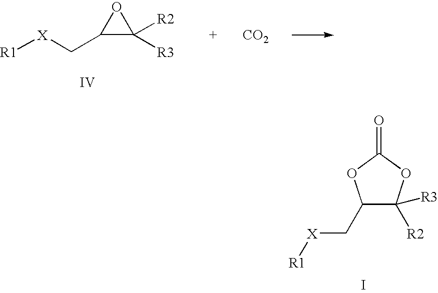
in which the symbols X, R¹, R² and R³ have the following meanings:
R¹ is a linear or branched, unsubstituted C₃-C₂₉-alkyl group or a linear or branched, unsubstituted C₃-C₂₉-alkenyl group;
R² and R³, independently of one another, are hydrogen or a linear or branched alkyl group;
X is selected from the group consisting of O, O(CH₂CHR⁴O)ₙ, S, NR⁵, COO and CONH, in which R⁴ and R⁵ are hydrogen, methyl, ethyl or propyl, and n is a number from 1 to 5, where mixtures of compounds with groups X of the formula O(CH₂CHR⁴O)ₙ are also included by the formula I, in which n has various numerical values.

31. A method as claimed in claim 30, wherein the epoxide of the formula IV is produced by reacting epichlorohydrin with suitable alcohols, thiols, alcohols reacted with alkylene oxides, amines, carboxylic acids, their esters or their carboxamides and subsequent or simultaneous elimination of HCl.

32. A method as claimed in claim 31, wherein the suitable alcohols, thiols, alcohols reacted with alkylene oxides, amines, carboxylic acids or their esters or carboxamides are chosen from linear or branched aliphatic C₃-C₂₉-alcohols with an average degree of branching which is defined as (number of methyl groups per molecule)-1 of from 0 to 2.5, where the alkyl chain can have further substituents which increase the suitability of the molecule as cosurfactant, but at least do not negatively influence it, Guerbet alcohols and their unsaturated analogs, and the substituted thiols corresponding to the suitable alcohols, alcohols reacted with alkylene oxides, amines, carboxylic acids and their carboxamides.

33. A detergent, household cleaner, body-cleansing composition or bodycare composition comprising at least one alkylglycidol carbonate as claimed in claim 21.

34. A detergent as claimed in claim 33 in solid, liquid, gel or paste form.

35. A detergent as claimed in claim 33, comprising 0.1 to 40% by weight based on the total amount of the formulation, of at least one alkylglycidol carbonate.

36. A household cleaner as claimed in claim 33 in liquid, gel or solid form.

37. A household cleaner as claimed in claim 36 in the form of a hand dishwashing detergent, machine dishwashing detergent, metal degreaser, glass cleaner, floor cleaner, all-purpose cleaner, high-pressure cleaner, alkaline cleaner, acidic cleaner, spray degreaser, dairy cleaner, upholstery cleaner, plastic cleaner and bathroom cleaner.

38. A household cleaner as claimed in claim 36, comprising 0.01 to 40% by weight based on the total formulation, of at least one alkylglycidol carbonate.

39. A body-cleansing composition or bodycare composition in the form of a shampoo, shower or bath gel, shower or bath lotion, a lipstick, a cosmetic formulation with care and/or conditioning properties or a styling product, a liquid soap, a care cream, a hair foam, hair gel, hair spray or after-treatment composition, a hair tonic, a lotion, treatment rinse, treatment pack, a split-end fluid, hair repair composition, hot oil treatment, hair-setting composition, hair colorant or permanent waving agent, comprising at least one alkylglycidol carbonate as claimed in claim 21.

40. A method for producing an alkylglycidol carbonate as claimed in claim 27, comprising reacting 1,2-diols of the formula II and functionalized with an R¹—X—CH₂ group with phosgene in accordance with the following reaction scheme: 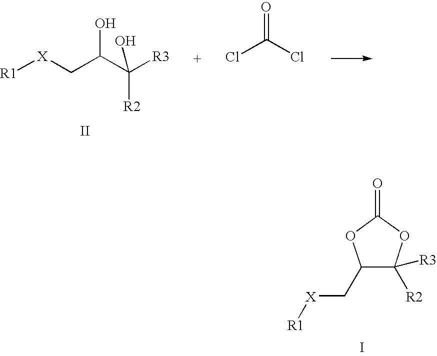
in which the symbols X, R¹, R² and R³ have the following meanings:
R¹ is a linear or branched, unsubstituted C₃-C₂₉-alkyl group or a linear or branched, unsubstituted C₃-C₂₉-alkenyl group;
R² and R³, independently of one another, are hydrogen or a linear or branched alkyl group;
X is selected from the group consisting of O, O(CH₂CHR⁴O)ₙ, S, NR⁵, COO and CONH, in which R⁴ and R⁵ are hydrogen, methyl, ethyl or propyl, and n is a number from 1 to 5, where mixtures of compounds with groups X of the formula O(CH₂CHR⁴O)ₙ are also included by the formula I, in which n has various numerical values.

41. A method for producing an alkylglycidol carbonate as claimed in claim 27, comprising reacting epoxides of the formula IV according to the following reaction scheme with CO₂ using a catalyst: 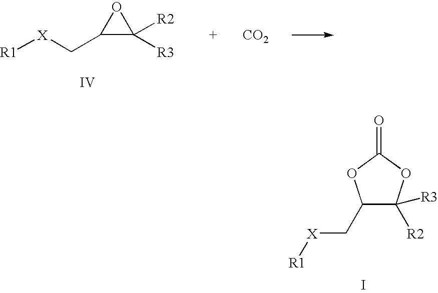
in which the symbols X, R¹, R² and R³ have the following meanings:
R¹ is a linear or branched, unsubstituted C₃-C₂₉-alkyl group or a linear or branched, unsubstituted C₃-C₂₉-alkenyl group;
R² and R³, independently of one another, are hydrogen or a linear or branched alkyl group;
X is selected from the group consisting of O, O(CH₂CHR⁴O)ₙ, S, NR⁵, COO and CONH, in which R⁴ and R⁵ are hydrogen, methyl, ethyl or propyl, and n is a number from 1 to 5, where mixtures of compounds with groups X of the formula O(CH₂CHR⁴O)ₙ are also included by the formula I, in which n has various numerical values.

42. A method as claimed in claim 41, wherein the epoxide of the formula IV is produced by reacting epichlorohydrin with suitable alcohols, thiols, alcohols reacted with alkylene oxides, amines, carboxylic acids, their esters or their carboxamides and subsequent or simultaneous elimination of HCl.

43. A method as claimed in claim 42, wherein the suitable alcohols, thiols, alcohols reacted with alkylene oxides, amines, carboxylic acids or their esters or carboxamides are chosen from linear or branched aliphatic C₃-C₂₉-alcohols with an average degree of branching which is defined as (number of methyl groups per molecule)-1 of from 0 to 2.5, where the alkyl chain can have further substituents which increase the suitability of the molecule as cosurfactant, but at least do not negatively influence it, Guerbet alcohols and their unsaturated analogs, and the substituted thiols corresponding to the suitable alcohols, alcohols reacted with alkylene oxides, amines, carboxylic acids and their carboxamides.

44. A detergent, household cleaner, body-cleansing composition or bodycare composition comprising at least one alkylglycidol carbonate as claimed in claim 27.

45. A detergent as claimed in claim 44 in solid, liquid, gel or paste form.

46. A detergent as claimed in claim 44, comprising 0.1 to 40% by weight, based on the total amount of the formulation, of at least one alkylglycidol carbonate.

47. A household cleaner as claimed in claim 44 in liquid, gel or solid form.

48. A household cleaner as claimed in claim 47 in the form of a hand dishwashing detergent, machine dishwashing detergent, metal degreaser, glass cleaner, floor cleaner, all-purpose cleaner, high-pressure cleaner, alkaline cleaner, acidic cleaner, spray degreaser, dairy cleaner, upholstery cleaner, plastic cleaner and bathroom cleaner.

49. A household cleaner as claimed in claim 47, comprising 0.01 to 40% by weight, preferably 0.1 to 25% by weight, based on the total formulation, of at least one alkylglycidol carbonate.

50. A body-cleansing composition or bodycare composition in the form of a shampoo, shower or bath gel, shower or bath lotion, a lipstick, a cosmetic formulation with care and/or conditioning properties or a styling product, a liquid soap, a care cream, a hair foam, hair gel, hair spray or after-treatment composition, a hair tonic, a lotion, treatment rinse, treatment pack, a split-end fluid, hair repair composition, hot oil treatment, hair-setting composition, hair colorant or permanent waving agent, comprising at least one alkylglycidol carbonate as claimed in claim 27.

51. A detergent as claimed in claim 33, wherein said detergent is in the form of a powder, compact, granules, tablet or gel.

52. A detergent as claimed in claim 33, comprising 0.5 to 30% by weight based on the total amount of the formulation, of at least one alkylglycidol carbonate.

53. A detergent as claimed in claim 33, comprising 1 to 20% by weight based on the total amount of the formulation, of at least one alkylglycidol carbonate.

54. A household cleaner as claimed in claim 33, wherein said household cleaner is in the form of a liquid, gel, powder or compact.

55. A detergent as claimed in claim 44, wherein said detergent is in the form of a powder, compact, granules, tablet or gel.

56. A detergent as claimed in claim 44, comprising 0.5 to 30% by weight based on the total amount of the formulation, of at least one alkylglycidol carbonate.

57. A detergent as claimed in claim 44, comprising 1 to 20% by weight based on the total amount of the formulation, of at least one alkylglycidol carbonate.

58. A household cleaner as claimed in claim 44, wherein said household cleaner is in the form of a liquid gel powder or compact.

59. A household cleaner as claimed in claim 36, comprising 0.1 to 25% by weight based on the total formulation, of at least one alkylglycidol carbonate.
